(19) United States
(12) Patent Application Publication
(10) Pub. No.: US 2009/0204590 A1
(43) Pub. Date: Aug. 13, 2009

(54) SYSTEM AND METHOD FOR AN INTEGRATED ENTERPRISE SEARCH

(75) Inventors: Steven Yaskin, Marlboro, NJ (US); Andrei Zudin, Moscow (RU)

Correspondence Address: FENWICK & WEST LLP, SILICON VALLEY CENTER, 801 CALIFORNIA STREET, MOUNTAIN VIEW, CA, 94041, US

(73) Assignee: Queplix Corp., Princeton, NJ (US)

(21) Appl. No.: 12/369,596

(22) Filed: Feb. 11, 2009

Related U.S. Application Data
(60) Provisional application No. 61/027,752, filed on Feb. 11, 2008.
(60) Provisional application No. 61/149,966, filed on Feb. 4, 2009.

(51) Int. Cl. G06F 17/30

(52) U.S. Cl. 707/3; 707/E17.108; 707/E17.045; 707/100

(57) ABSTRACT

Methods and systems allow integrated search in an enterprise environment that stores information in data silos. Entity type metadata, relations between entity types and other information related to entity types is extracted from the data silos. Metadata information extracted from multiple data silos is combined to construct a global data model for the enterprise. Entity instances present in the data silos are analyzed to generate documents representing the entity instances. Relations between documents are represented by links between documents. The documents generated are indexed to allow searching across the enterprise. Search results are presented in order of their importance to the searcher.

### CROSS REFERENCE TO RELATED APPLICATIONS

This application claims the benefit of, and priority to, U.S. Provisional Application No. 61/027,752, filed Feb. 11, 2008, which is incorporated by reference in its entirety. This application also claims the benefit of and priority to, U.S. Provisional Application No. 61/149,966, filed Feb. 4, 2009.

### BACKGROUND

1. Field of Art

The disclosure relates to searching information in an enterprise that has information stored in data sources across organizational silos.

2. Description of the Related Art

The search for information in the world of an enterprise, for example, corporation, non-profit organization, or government entity, is different from search for information on the internet or on an individual's desktop. Among many factors that make enterprise search unique are: (1) Information is behind the firewall and is usually not accessible from the outside world. (2) Information is contained in multiple entity silos that represent a vast amount of diverse computer systems that usually do not interact or share information with each other. (3) Most information is stored in the form of structured data in databases, as opposed to individual searches where most information is stored in the form of unstructured data, for example, documents, pictures, HTML (HyperText Markup Language) and XML (Extensible Markup Language) files. As a result, a search engine for searching information in an enterprise faces very different challenges compared to a search engine that allows searching on the internet or searching on an individual's desktop.

### SUMMARY

Methods and systems allow an integrated search in an enterprise environment. The enterprise data is available in data silos that are populated by systems or applications that may or may not interact with each other. In some embodiments, the data stored in the data silos is available in relational databases. Metadata including entity types, relations between entity types and other information including users, roles, or access control information is extracted from data silos of an enterprise. Metadata information extracted from multiple data silos is combined to construct a global data model for the enterprise that combines information that may be stored in different silos. Entity types representing the same underlying real world entities are combined into a global entity type. Similarly, other information related to entity types including relations, actions and access control information is combined. Entity instances present in the data silos are analyzed to generate documents representing the entity instances. Relations between documents are represented by links between documents. In some embodiments, metadata information is stored in XML format, entity instances are stored as HTML documents and relationship links between entity instances are stored as hyper text links. The HTML documents are indexed to allow searching using a search engine. The scheduling of the processing of the input data present in the data silos of the enterprise can be controlled to be either comprehensive for the entire data set or incremental in an iterative fashion or real-time for specific entity types. The search results presented to the user are filtered by the roles of the searcher to present only the results that the searcher is allowed to access. Results are presented to the searcher in order of their importance. The importance of a document is determined based on a score assigned to the corresponding entity instance.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a high-level diagram illustrating the overall approach towards the integrated enterprise search in accordance with an embodiment of the present invention.

FIG. 2 shows one embodiment of the architecture of a computer device that may be used to execute modules of the system in FIG. 3.

FIG. 3 illustrates the architecture of a system for allowing integrated enterprise search in accordance with an embodiment of the present invention.

FIG. 4 shows a flowchart describing the process for extracting information from multiple data silos and representing it in a format that allows integrated enterprise search in accordance with an embodiment of the present invention.

FIG. 5 illustrating how entity type relations are derived form foreign key relations between tables in accordance with an embodiment of the present invention.

FIG. 6 shows the system tables of SAP application used that can be used by an application connector of the crawler in accordance with an embodiment of the present invention.

FIG. 7 illustrates various embodiments of the processes for extracting entities from data silos in accordance with the present invention.

FIG. 8 shows a screenshot of the user interface of the designer tool for modifying the metadata discovered in accordance with an embodiment of the present invention.

FIG. 9 illustrates how entities may be combined by the federator to generate virtual entities in accordance with an embodiment of the present invention.

FIG. 10 illustrates how merging relations between global entity types results in an enterprise wide data model in accordance with an embodiment of the present invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

Information in an enterprise is available in multiple data silos and includes large amount of structured data that may be stored in relational databases along with unstructured data. For example, the data silos may correspond to different applications run in the enterprise that may not interact with each other. An integrated enterprise search system provides capability to search multiple structured and unstructured data sources across multiple data silos with a single query. The integrated enterprise search system provides fast query response, relevant results ranked in an order that allows a user to easily locate information of interest to the user. Furthermore, a user is allowed to see only the results that the user is allowed to access in the enterprise. The relevancy of search results for an enterprise search user is different from the relevancy of search results in an internet search of desktop search. For example, relevancy of search results in an enterprise search is based on factors including, the role of the user, frequency of entity transactions, or last transaction time. Entities in an enterprise may have transactions associated with them. An enterprise search should be capable of presenting the updated entity based on the latest transactions in real time.

An entity type refers to an abstraction of a real world object and its associated processes, for example, a customer and the various interactions possible with a customer. Similar to real world entities, entity types can be linked to each other, consist of several attributes, change their state and execute certain actions. For example, an entity type can be defined to encapsulate an object representing a “support engineer” or a “customer enquiry.” The entity type representing a “support engineer” can have attributes including, first and last names, position, and supervisor. Similarly, the entity type representing a “customer enquiry” can have attributes including enquiry time, status, and the customer requesting the enquiry. The two entity types can be related to each other, for example the “customer enquiry” may have a “support engineer” working on the enquiry to resolve it. The state of the entities can also change over time, for example, the working hours of the “support engineer” can change, the status of the “customer enquiry” can change when it is resolved. Entities can execute associated actions, for example, if a “customer enquiry” is resolved, the information regarding the resolution may be published in a knowledge base. Entity types are similar to classes in the object-oriented programming paradigm. However the major difference is that entity types are abstractions of persistent objects that may not have a central coordinator of their life cycle or location. An entity instance refers to a particular instance of an entity type, for example, Joe and Bob may be two support engineers and a distinct entity instance of the entity type “support engineer” may represent each support engineer.

Different data silos within an organization may contain the same entity with data that is common across different silos as well as data that is specific to each silo. An instance of an entity when returned as part of an integrated enterprise search result combines the relevant information appropriately so as to appear as one unified entity rather than disparate representations of the same entity. In an enterprise, some information may be available, but restricted for access to certain users, based on their roles and permissions. The search results presented to a user invoking a search contain only entities that the user is allowed to access in the enterprise. Besides, an entity included in the search results includes only attributes that the user is allowed to access.

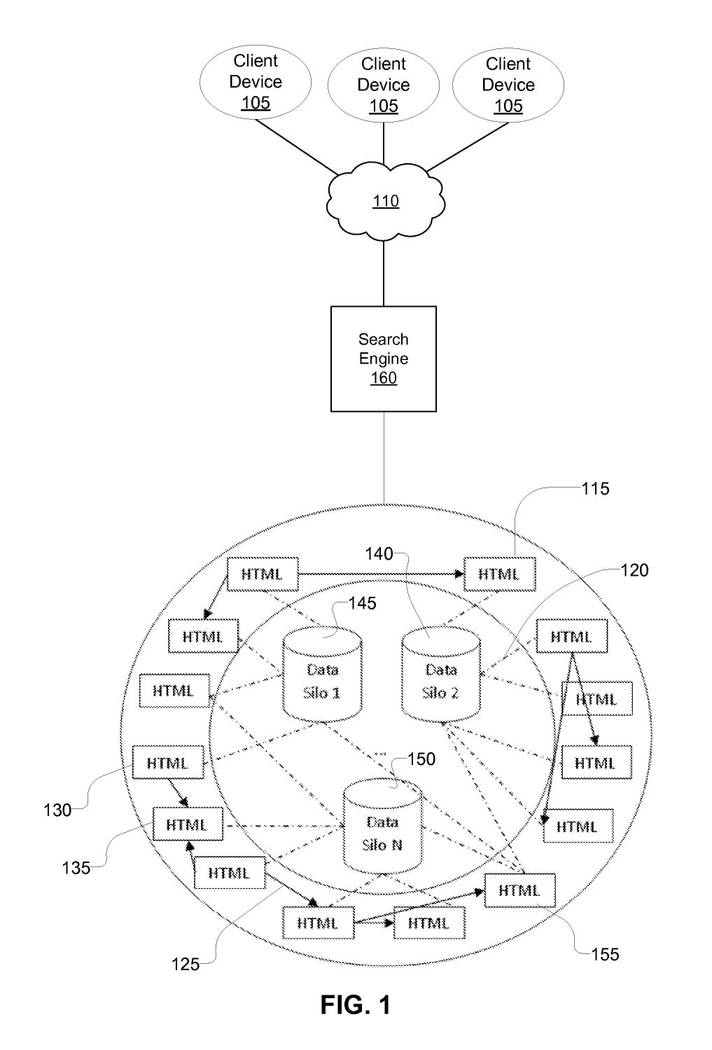

FIG. 1 presents the overall approach towards the integrated enterprise search system. Information stored in selected data silos of an enterprise is used as input to build a virtual website-like representation of all the information stored in chosen data silos in the enterprise. Information including records stored in relational databases, objects, documents and the like are represented as web pages 115 that are linked to each other, for example, using standard HTML links 125. The links 120 shown in FIG. 1 between HTML web pages and the data silos represent source data silo from where information stored in a web page was obtained. An HTML web page 130 can have a link to another web page 135 even though the two web pages are derived from separate data silos 145 and 150 respectively. If an HTML web page is based on an instance of entity represented in multiple data silos, the HTML page 155 may include information from multiple data silos, for example, data silos 140 and 150. The web pages of the virtual website can be indexed by a search engine 160 with capability to index documents with links between the documents, for example, HTML documents with standard web reference links. The term document refers to an electronic document that can be processed by a computer. Users can conduct enterprise searches over the search engine 160 using client devices 105 communicating with the search engine 160 over the network 110.

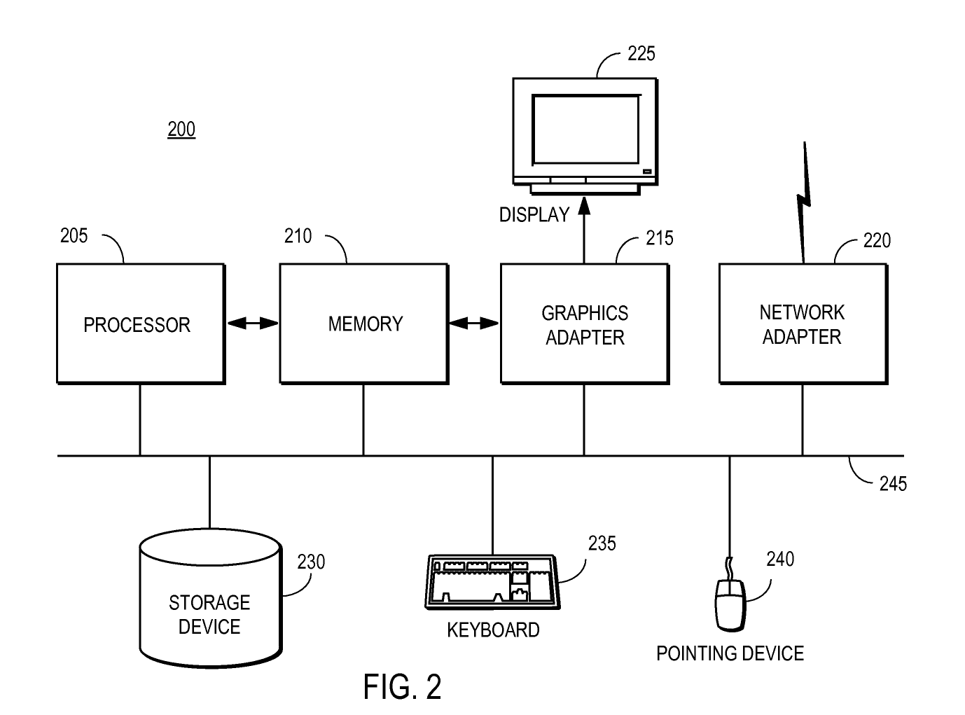

Next, FIG. 2 is a high-level block diagram illustrating a functional view of a typical computer 200 for executing the various modules required for the integrated enterprise search system. Illustrated are at least one processor 205 coupled to a bus 245. Also coupled to the bus 245 are a memory 210, a storage device 230, a keyboard 235, a graphics adapter 215, a pointing device 240, and a network adapter 220. A display 225 is coupled to the graphics adapter 215.

The processor 205 may be any general-purpose processor such as an INTEL compatible-CPU (central processing unit). The storage device 230 is, in one embodiment, a hard disk drive but can also be any other device capable of storing data, such as a writeable compact disk (CD) or DVD, or a solid-state memory device. The memory 210 may be, for example, firmware, read-only memory (ROM), non-volatile random access memory (NVRAM), and/or RAM, and holds instructions and data used by the processor 205. The pointing device 240 may be a mouse, track ball, or other type of computer (interface) pointing device, and is used in combination with the keyboard 235 to input data into the computer system 200. The graphics adapter 215 displays images and other information on the display 225. The network adapter 220 couples the computer 200 to the network.

As is known in the art, the computer 200 is adapted to execute computer program modules. As used herein, the term “module” refers to computer program logic and/or data for providing the specified functionality. A module can be implemented in hardware, firmware, and/or software. In one embodiment for software and/or firmware, the modules are stored as instructions on the storage device 230, loaded into the memory 210, and executed by the processor 205.

The types of computers 200 utilized by an entity can vary depending upon the embodiment and the processing power utilized by the entity. For example, a client device 105 typically requires less processing power than a server used to run a search engine. Thus, the client device 105 can be a standard personal computer system. The server, in contrast, may comprise more powerful computers and/or multiple computers working together (e.g., clusters or server farms) to provide the functionality described herein. Likewise, the computers 200 can lack some of the components described above. For example, a computer 200 may lack a pointing device, and a computer acting as a server may lack a keyboard and display.

### System Architecture

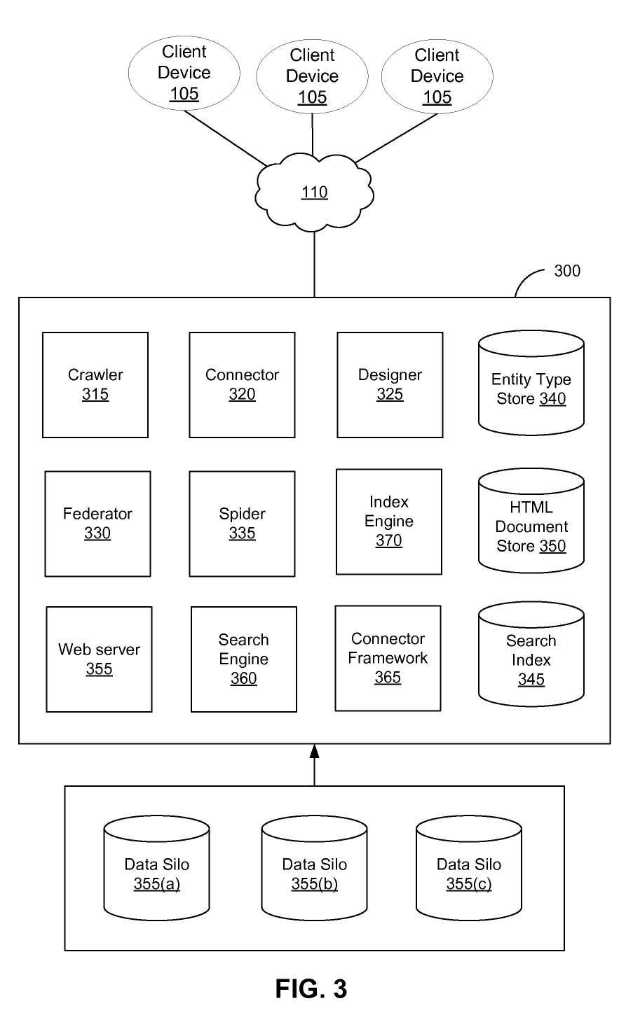

FIG. 3 is a high-level block diagram illustrating a system environment suitable for an integrated enterprise search. The system environment comprises one or more client devices 105, a network 110, and an integrated enterprise search system 300. In alternative configurations, different and/or additional modules can be included in the system.

The client devices 105 comprise one or more computing devices that can receive member input and can transmit and receive data via the network 110. For example, the client devices 105 may be desktop computers, laptop computers, smart phones, personal digital assistants (PDAs), or any other device including computing functionality and data communication capabilities. The client devices 105 are configured to communicate via network 110, which may comprise any combination of local area and/or wide area networks, using both wired and wireless communication systems.

The integrated enterprise search system 300 comprises a computing system that takes data available in various data silos 355 of an enterprise as input and converts it to a format that allows an enterprise user to perform searches. The integrated enterprise search system 300 includes a crawler 315, one or more connectors 320, a federator 330, a spider 335, a designer 325, a web server 355, a search engine 360, an index engine 370, a connector framework 365, an entity type store 340, an HTML document store 350, and a search index 345.

In other embodiments, the integrated enterprise search system 300 may include additional, fewer, or different modules for various applications. Conventional components such as network interfaces, load balancers, failover servers, management and network operations consoles, and the like are not shown so as to not obscure the details of the system.

The crawler 315 is responsible for initial discovery and extraction of business entity types and relationships between them across various data silos 355 in the enterprise. The connector 320 module allows the crawler 315 to connect to third party applications to discover entity types in the data stored in the applications. There may be different connectors 320 for connecting to different applications in the enterprise. The connector framework 365 allows the crawler 315 to execute logic provided as connectors for discovering metadata from the data silos 355. The designer 325 provides a visual interface to allow an administrator (an administrator refers to any privileged user allowed to perform specialized tasks, for example, tasks related to system configuration) to control the discovery and extraction of the crawler 315. The designer 325 also allows an administrator or business analyst to maintain the information extracted and modifying the extracted information if needed. The federator 330 takes the entity types extracted by the crawler 315 and recognizes common entity types across all the entities discovered across the various data silos 355 and merges them appropriately to create global entity types. The raw entity types as well as the global entity types discovered are stored in the entity type store 340. The federator 330 also processes the data in the data silos 355 to generate HTML documents for the discovered entity instances that are stored in the HTML document store 350. The HTML documents in the HTML document store 350 are indexed by the index engine 370 to create a search index 345. The web server 355 receives incoming requests from the client devices 105 and forwards the requests to the search engine 360. The search engine 360 processes the incoming search requests and returns the search results to the requestor. The spider 335 is an ongoing process that queries various data silos for changed information and feeds the changes to the federator 330 which are ultimately fed to the index engine 370 and to the search engine 360. The overall process based on one embodiment of the method used by integrated search system is described below, followed by the detailed description of the various modules.

### Overall Process

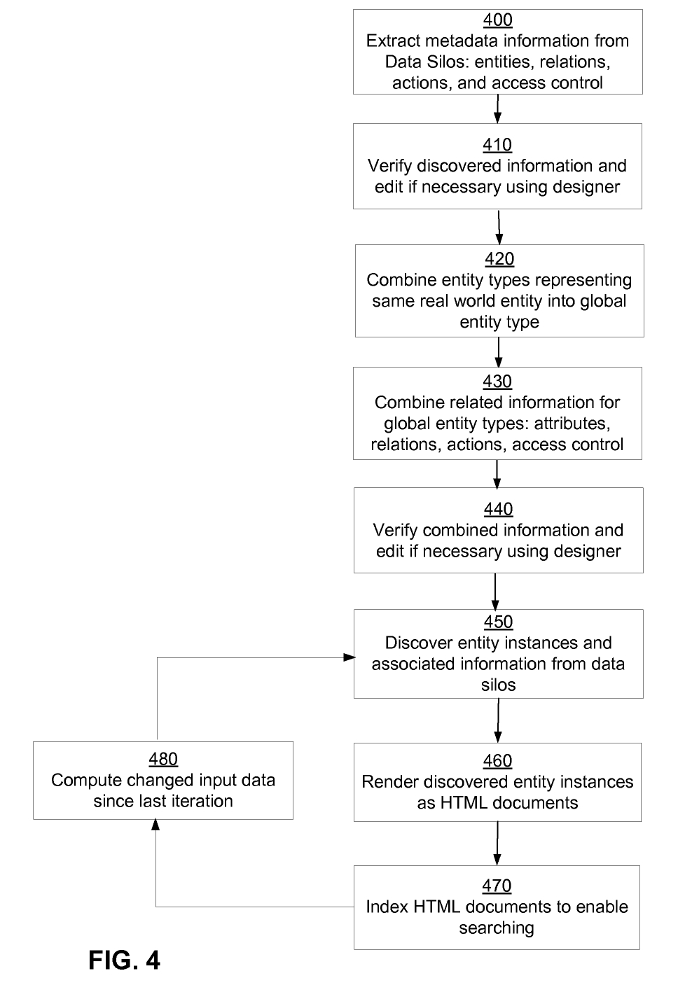

FIG. 4 shows a flowchart describing an embodiment of the process for extracting information from multiple data silos and representing it in a format that allows integrated enterprise search. Metadata information is extracted 400 from data silos in an enterprise by the crawler 315. The information extracted includes different kind of information available in the data silos including entity types, relations between entity types, actions associated with entity types, and access control or security information associated with entity types. An administrator can verify 410 the discovered information using the designer 325 and make modifications if needed. In general, the modifications are allowed if they are consistent with the data model. Entity types that represent the same real world entity but are obtained from different data silos are combined 420 by the federator to generate a global entity type that encapsulates the real world entity and stores the information available in the different representations of the entity type. If two or more entity types are combined into a global entity type, the related information associated with the entity type are also combined, for example, the attributes, actions, relations associated with the entity types as well as access control information. The combined information can be verified by an administrator using the designer 325 and modified if needed. The metadata generated by the crawler 315 and federator 330 is stored in a suitable format, for example, XML document format.

The metadata information collected by the crawler 315 and federator 330 is used to discover 450 the appropriate entity instances and their related information from the data silos of the enterprise. The associated information includes information for an entity instance, for example, related entity instances or access control information. The discovered entity instances are rendered 460 as documents that can be indexed. The format used for rendering entity instances is any suitable format that can represent the information associated with the entity instances including the relations between the entities, for example HTML format. The documents generated are indexed 470 by an index engine 370 so they can be searched by a search engine 360. The process of discovering 450 new entity instances, rendering the discovered entity instances and their related information using documents, and indexing the document is repeated to incorporate changes in the information in the data silos over time. For example, the process can be repeated periodically to compute 480 the relevant changes in the data silos since the last iteration of the process. The process is repeated for the changed information. Other embodiments of the scheduling of the process of discovering 450, rendering 460, and indexing 470 are presented in the section on spider described below.

### Crawler

The crawler 315 maintains a metadata catalogue for storing the metadata of the discovered entity types in XML files including associated information including relations between entity types. The crawler 315 also discovers security information including predefined user accounts, security roles, and associated permissions. In one embodiment the crawler can extract the security information from an identity management software, for example, LDAP (Lightweight Directory Access Protocol) server. Alternatively, the crawler can use an application metadata connector (described below in detail) that encodes information related to the database schema including the tables that contain security information including users, roles, permissions etc. A user can also specify the database tables containing security information using the designer tool (described below in detail). In an embodiment, the crawler 315 extracts metadata related to entity types but does not extract entity instances. The information maintained by the crawler 315 in the metadata catalogue is available for other modules to use.

The entity type discovery performed by the crawler 315 can be based on analysis of database schema if a data silo stores information in relational database management systems. Alternatively the discovery can be based on application connectors if the data source is associated with an application. Even if the application stores its data in a relational database management system, the connector can provide additional information that makes the discovery efficient, leading to discovery of more or better information. If no special connector or additional information related to a data silo is available, the automatic discovery based on the schema of the relational database management system is used. The crawler 315 reads the data schema of each data silo's database including tables, views, primary and foreign keys, and additional constraints. The crawler 315 determines stand-alone entity types and identifies other entity types that can be linked to an entity type as attributes. By linking entity types with each other based on references between entity types, a hierarchy of entity types is created. A score is assigned to each entity type that is indicative of the relevance of an instance of the entity type that is presented to the viewer as part of search results. Entity types with higher score are considered more relevant to a user compared to entity types with lower score and are hence moved higher up in the order of search results.

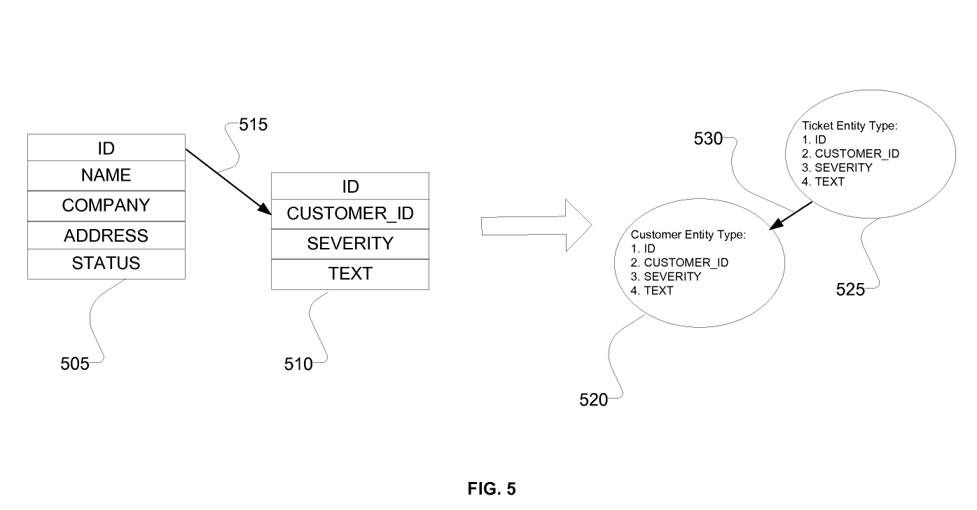

Each table becomes an entity type with unique primary identifier determined either by primary key constraint or by analyzing table data. For example, if a table does not define a primary key, the various columns of the table can be examined to determine if one or more columns can be used to define a unique primary identifier. Foreign key constraints become relations between corresponding entities. FIG. 5 illustrates how foreign key constraints become relations between entity types. The relation 515 is a foreign key relation between a table 505 representing a customer and table 510 representing a trouble ticket representing a problem faced by the customer. The column CUSTOMER_ID in table 510 contains values from the column ID of table 505 allowing a trouble ticket instance to refer to a customer. The entity types corresponding to the above table structure includes entity type 520 representing the customer entity type and the entity type 525 representing the trouble ticket entity type. The trouble ticket entity type 525 has a relation 530 to the customer entity type 520. Note that by convention the relationship arrow in the relational database tables is displayed as the reverse of the arrow in the entity types, for example, the arrow outgoing from the customer table 505 is represented as an incoming arrow in the customer entity type 520.

Scores are assigned to tables based on various factors, including the number of foreign key relations outgoing from the table. Larger the number of outgoing foreign keys from a table, the higher the score assigned to the corresponding table. The score of a table can be considered a sum of scores assigned to each outgoing relation where the score of an outgoing relation depends on the target table of the relation. For example, a relation going to a table with higher score is assigned a higher score than a relation going to a table with low score. If a relation has a target table representing users, the score of the relation is also determined based on the roles assigned to the users in the target table. For example, users representing executive employees of an enterprise may be given higher score compared to non-executive employees. The scores of the relational tables can be translated to scores of the corresponding entity types. Thus, an entity type that has a large number of entity type relations incoming has a higher score than an entity type with few incoming entity type relations. Tables with higher scores become higher-level indexable entities and may be represented higher up in the entity type hierarchy compared to tables with lower scores. Tables with smaller scores may be defined as dictionaries or attributes of higher positioned tables. The information necessary to compute the entity types score as well as other weighting criteria useful for determining the relevance of an entity instance to a searcher is stored along with the metadata of the entity type. This information is used by the search engine 360 to compute scores of entity instances returned as search results. The entity instance score is used to determine the order of relevancy of the entity instances in the search results used to determine the order in which the search results are presented to the user. For example, the entity instance score can be determined such that an entity instance with higher entity instance score is presented higher up in the order of search results compared to an entity instance with lower entity instance score, assuming the access permissions of the searcher allow the searcher to view the corresponding entity instances.

Column data types from each table are analyzed and appropriate formatting applied for indexing. For example, timestamps are converted to a format recognized by search engine. CLOB (Character Large OBject) and BLOB (Binary Large OBject) fields are converted into HTML format. References between entities become URLs (Uniform Resource Locator).

The crawler 315 can be provided with application connectors that include logic specific to an application that is useful for discovery of a more efficient and accurate entity type hierarchy and associated information. The connectors also help with discovery of security and access control information that is retrieved as part of the metadata discovery. A connector contains predefined metadata representing knowledge about the application of the database being crawled. The connector framework 365 allows a user to create a connector 320 as well as execute it. The connector framework 365 defines a set of APIs (Application Programming Interface) for connecting specific data silos to the integrated enterprise search system. Using these APIs, the quality of the metadata discovered can be improved since logic specific to a data schema or an application can be incorporated.

The connector framework 365 defines a set of application-level contracts between the integrated enterprise search system and connectors 320 to external systems. Besides extraction of metadata, the connector framework 365 is designed to extract user accounts and their corresponding permissions to search entities. The connector framework 365 also allows connecting to and reading from LDAP as well as applications, for example, SAP, SEIBEL, SALESFORCE.COM, etc. An example connector 320 for the SAP application is described below.

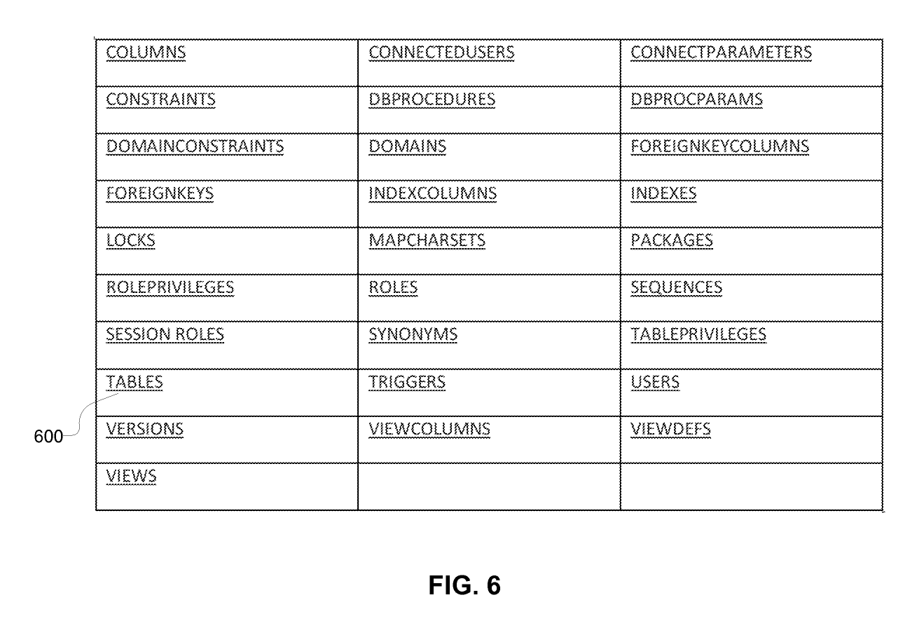

Although SAP applications are highly customized implementations, they contain a set of metadata tables called system tables that store information about all entity types used in SAP application including the entity types that are provided as part of the application as well as custom entity types defined by the SAP user. The SAP connector helps reading all the metadata information it requires from the SAP metadata tables to determine what entity types exist and can be potentially indexed. The SAP system tables also include information related to connections between entity types. The connector logs in as a read only user to the SAP system with privileges to access the system tables. The various system tables 600 in an SAP application are illustrated in FIG. 6. For example, the system tables including USERS, ROLES, ROLEPRIVILIGES etc. provide information related to users, their roles, and privileges (also called permissions). The extracted metadata is stored and can be superimposed with globalized metadata obtained from various data silos across the enterprise.

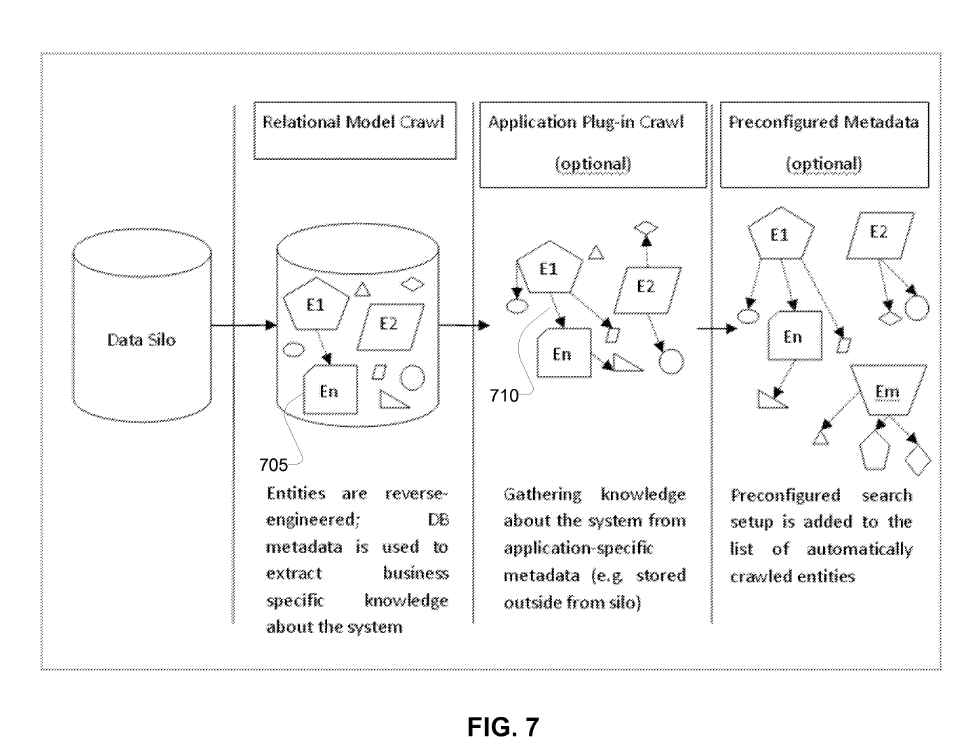

Certain applications provide all the metadata required for using the application without requiring any customization or modifications. These applications can distribute standard metadata dictionary. For example, data dictionaries can be standardized for hosted systems like SALESFORCE.COM. Preconfigured metadata dictionaries can be provided for these and similar applications and provide help constructing the entity type hierarchy and related metadata information. FIG. 7 illustrates how the use of the above mechanisms to extract entities allows potentially different numbers of entity types 705 and their relations 710.

Non-structured data silos are crawled by repository names based on the repository hierarchy. Typically the bottom-level containers become entity types and documents under these containers become entity instances. A bottom-level container is a hierarchical element of file storage: i.e. folder, data storage repository, LDAP container, etc. It is a logically grouped “collection” of documents.

The crawler 315 can be executed against multiple data silos. The metadata generated by the crawler 315 becomes the building block for the designer 325 to establish relations between entity types within the same or separate data silos and federator 330 to combine multiple entities into global entities. Besides the discovery of entity types, the crawler 315 also analyzes the best way to determine the last modification date of the data of the entity instances. For relational database data sources the last modification date or time may be available as fields that contain date or timestamp of transactions or data changes. For non-structured data repositories the last modification date or time can be determined by the last modified attribute in the repository metadata. The last modified date or time information is used to determine the data that changed since the last time the data was indexed.

### Designer

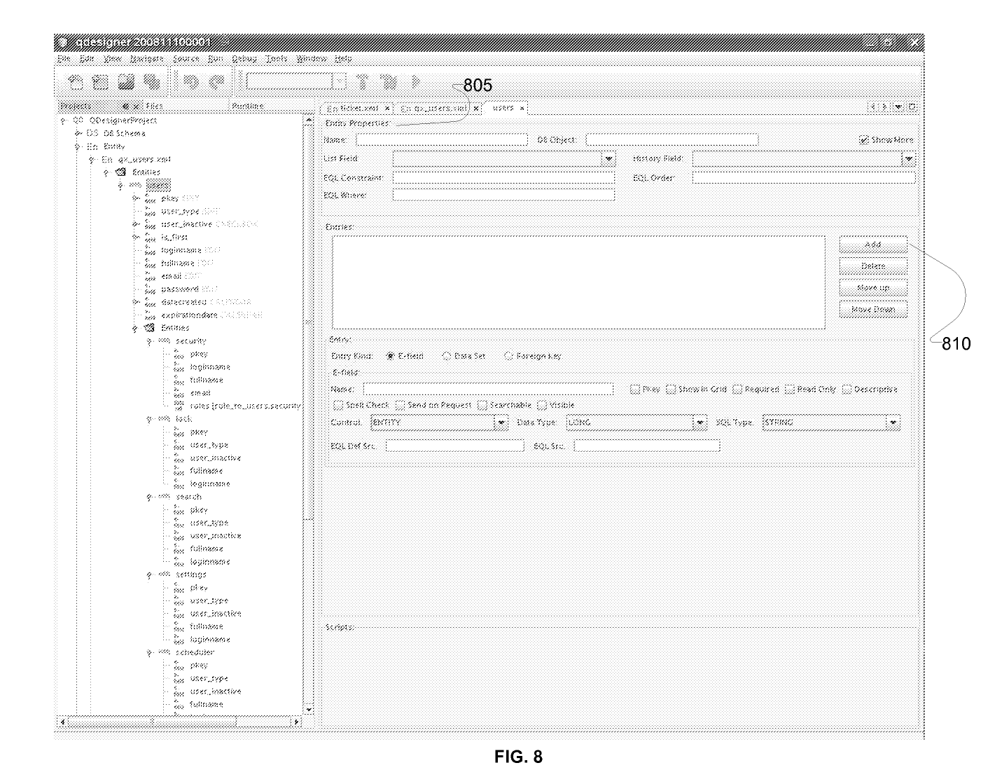

The designer 325 is a visual interface to the crawler 315 that allows an administrator to establish connectivity to data silos of the enterprise and control the crawler 315 discovery and extraction process. FIG. 8 presents a screenshot of the designer 325 illustrating how the properties of an entity 805 can be viewed and edited if needed using the appropriate controls 810 provided in the user interface. The designer 325 also allows the administrator or a business analyst to maintain the extracted business entity types, user accounts, permissions, relations between entity types, relations between user and entity types and the like. The designer 325 provides graphical controls to enable modifying entity definitions in required but valid ways, for example, the designer 325 may not allow a user to create a new attribute for an entity type if the attribute does not exist anywhere in the underlying storage. The designer 325 allows modifications to the discovered metadata to better reflect real life information. For example, if there was no foreign key constraint between two tables in the underlying database schema and the crawler 315 failed to link the two entity types based on other mechanisms like connectors or preconfigured metadata dictionary, the relation can be manually introduced with the help of the designer 325 if needed.

The designer 325 also allows changing the default template used for generation of HTML document for each entity. The designer 325 also allows identifying and linking application actions with entity types and user roles. These actions are displayed next to the search result if an appropriate entity instance is displayed to a user with the selected role. The user performing the search can select an appropriate action to invoke the associated application. The associated application when invoked, further initiates the requested action through an appropriate API.

### Federator

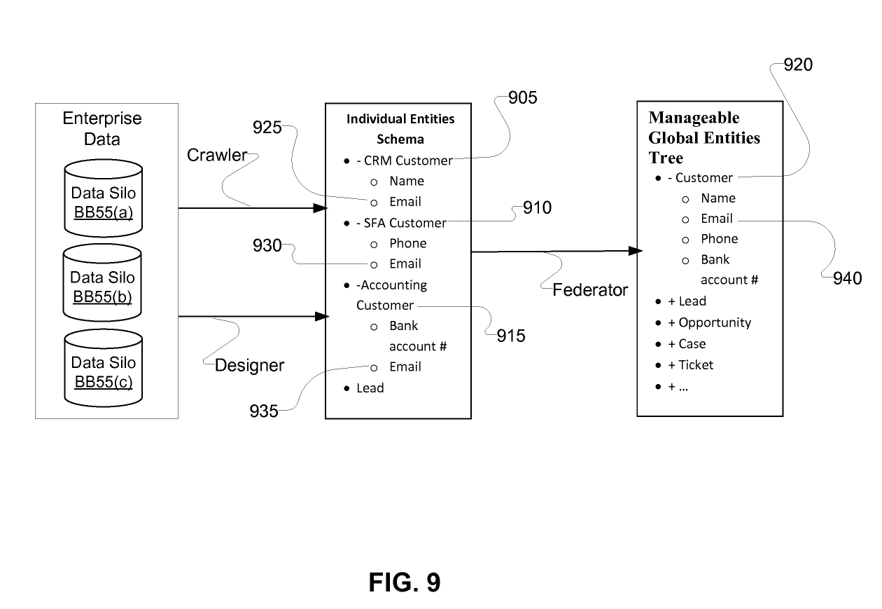

The federator 330 analyzes entity types extracted by the crawler 315 and possibly modified using the designer 325 to recognize common entities across all data silos crawled for the enterprise and merges them to create global entities. For example, a customer entity may exist in different data silos possibly associated with different applications. The federator 330 recognizes that the different customer entities defined in different data silos represent the same entity and creates a global customer entity type. For example, FIG. 9 shows the different customer entity types 905, 910, and 915 extracted from various data silos 355(a), 355(b), and 355(c). The different entity types discovered may have differences, for example 915 has an attribute “Bank account #” that is not present in customer entity types 905 and 910. The federator 330 combines the entity types 905, 910, and 915 to create a global entity type 920. The global entity type 920 includes the attributes present in the raw entity types used construct it.

The federator 330 analyzes the metadata as well as data in the underlying database tables to determine if two entity types can be combined into a global entity type. The federator 330 uses semantic criteria to identify entity types for globalization or merging. It looks at the actual data in entity instances and compares such data for commonality. Within the data fields it can recognize unique identifiers, such as referential integrity external foreign keys, email addresses, social security numbers, LDAP user IDs, and semi-unique identifiers such as people's names, addresses, etc. For example, if two entity types extracted from two different data silos represent the same global entity type representing the same real world entity, individual entity instances have the same or similar values of identifying attributes. For example, if two data silos have entity types representing a customer, an individual instance of a customer in the two data silos has the same social security number, and the same representation of the name. Unique identifying strings are likely to have the exact same values across two different representations of an entity instance. Semi-unique attributes may have variations in the way they are represented, for example, name of a customer. One entity instance may represent the last name followed by the first name whereas another entity instance may represent first name followed by last name. However, the commonalities in the name representation can be detected by processing the name strings.

Based on commonalities of entity instances detected between entity types, the federator 330 determines whether to combine entity types into one globalized entity. If certain entity types are determined to be common across data silos, the entity types are combined by the federator 330 into global entity types. The metadata of the global entity type stores information related to the various entity types combined into the global entity type. An administrator can define different levels of tolerance in determining whether to combine entity types into global entity types. Stricter level of tolerance requires entity types to be determined to be combinable into global entity types only of unique identifiers match between entities, for example, matches based on social security numbers of employees. Relaxed levels of tolerance allow combining entity types if semi-unique identifiers are determined to be common between non-related entities, for example, customer name John and employee name John. The tolerance level can be specified for the whole enterprise or for specific entity types. When entity types are combined into global entity types, individual entity instances are combined into global entity instances. When two entity instances are combined into a global entity instance, the different attributes of the individual entity instances are merged to determine the attribute value of the global entity instance. Conflict resolution rules can be defined that allow attributes values of the global entity instances to be determined in cases where individual attributes of entity instances being combined fail to match.

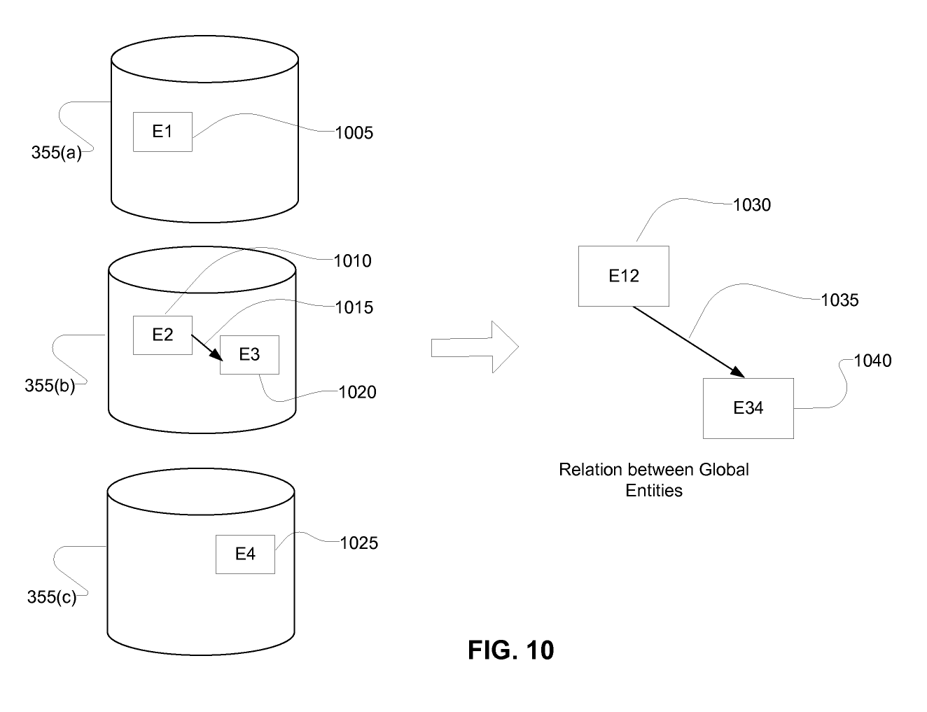

The federator 330 extends the raw entity type metadata descriptors generated by the crawler 315 in order to produce global entity types. (1) The persistence storage definition of each entity type describing the source data silo of the entity type is extended with the list of storage definitions of merged individual entities. (2) The list of attributes of individual entity types is merged into the list of attributes of the global entity type. Certain attributes from different individual entity types are represented by a single attribute in the global entity type. For example, as shown in FIG. 9, attribute “Email” 925, 930, and 935 present in the entity types 905, 910, and 915 respectively, is represented by a single attribute 940 in the global entity called “Email.” If multiple attributes are merged into a single attribute in a global entity, conflict resolution rules are established to determine the value of the merged attribute in case the corresponding attribute values of individual entity instances do not match. Violations resolved using conflict resolution may be monitored by an administrator. Each global attribute metadata contains information describing its source data silos. Merged attributes refer to all the data silos containing the source entity types whereas single attributes based on a single entity type refers to a single data silo containing the source entity type. (3) List of relations of individual entity types are merged into a global list of relations, for example if the source entities can be combined and the target entities can be combined then the relations can be combined. Conflicts are resolved using conflict resolution rules that can be monitored. Merging of relations allows building an enterprise wide data model where information from various unrelated data silos can be linked to each other. For example, FIG. 10 shows an enterprise with three data silos 355(a), 355(b), and 355(c). Entity type E1 1005 is discovered in data silo 355(a), entity types E2 1010, E3 1020 and a relation 1015 between E2 and E3 is discovered in data silo 355(b), and entity type E4 1025 is discovered in data silo 355(c). The federator 330 combines entity types E1 1005 and E2 1010 into a global entity E12 1030 and combines entity type E3 1020 and E4 1025 into a global entity E34. The relation 1035 between global entities E12 1030 and E34 1040 allows linking of entity types E1 1005 and E4 1025 that belong to different data silos with no relation between the underlying tables. Hence federator 330 creates a global data model linking data across the enterprise. For example, the entity type E1 1005 may represent emails from an email application (for example, MS Exchange) that stored data in a silo, E4 1025 may represent customer account in an accounting application that stores data in another silo, and the relation 1015 may be obtained from a contact management module of a CRM (Customer Relationship Management) application that stores data in a third data silo. (4) Actions applicable to each individual entity are merged into the global entity's metadata. The enterprise application that is the action executor for each action can be determined based on the source data silo or application using the information stored in the metadata. (5) Lists of access permissions for each security role/user are merged. Field-level security is applied (a field refers to the storage definition corresponding to an attribute).

In some embodiments, the federator 330 updates global information periodically. In other embodiments, the federator 330 updates information in real time as changes occur. The federator 330 renders the globalized information in the form of documents, for example, HTML and XML documents. The documents generated by the federator 330 can be fed in real time to a search engine 360. The output of the federator 330 is a document for each entity instance that is indexed by the index engine 370. In some embodiments, the documents generated by the federator 330 are HTML documents. The document representing an entity instance contains the metadata or descriptor and value pairs of the information extracted from the source.

Relations are identified between an entity instance and other entity instances. If a relation instance is found from a source entity to a target entity, a document link is added to the document corresponding to the source entity, the link pointing at the document corresponding to the target entity. In embodiments where the documents format is HTML, the document reference is stored as a hypertext link in the source document. These links are analyzed by search engines when associating a rank to the given data element. A document corresponding to an entity instance pointed at by a large number of entity instances may be ranked higher than a document with fewer relationships pointing to it. The rank of a document corresponding to an entity instance also depends on the rank of an entity instance pointing to it. For example, assume an entity instance e1 has a link to entity instance e2 and an entity e3 has a link to entity e4, and these are the only links to e2 and e3. If the rank of e1 is higher than the rank of e2 the rank of e3 is determined to be higher than the rank of e4. If an entity instance is pointed at by users, the rank of a document corresponding to an entity instance is also determined based on the roles of the users pointing at it. For example, an entity instance pointed at by a user representing an executive in a company may be ranked higher than an entity instance pointed at by less important users.

### Spider

The federator 330 works in coordination with the spider 335. The spider 335 analyzes all the data silos to determine the information that has changed incrementally since the last iteration. The changed information is fed to the federator 330 for processing. The spider 335 schedule can be adjusted by an administrator to minimize its effect on the systems being processed by the spider 335. A flag can be set by an administrator to force the process of discovery of entity instances, rendering the entity instances as documents, and indexing of the documents for the entire data set in the data silos of the enterprise. An administrator can mark certain entity types for immediate indexing, such that instances of these entity types are processed for indexing as soon as their associated data changes. For example, if the entity type for “customer enquiry” is marked for immediate indexing, as soon as any instance of “customer enquiry” changes any attribute value or other associated information including access control information, the entity instance is indexed as soon as it changes. Hence the document rendered corresponding to the changed entity instance is updated to reflect the change to the entity instance. The ability to change the indexed documents immediately in response to a change in the entity instance allows the changes to the entity to be observed in real time as a user performs a search that returns the entity in the search result. In practice, certain delays may occur due to various factors including slow processing speeds of computers or network delays but the changes can be considered to occur in real time for practical purposes.

### Search Engine

The search results are filtered by the access permissions of the user performing the search. For example, if a customer support representative searches for a particular customer name, the customer support representative is presented with business entities on top of the search results such as the customer's trouble tickets, knowledge base articles related to the customer's products and other business entities that relate to the customer representatives role. If the same search for a particular customer name is performed by an accounts payable specialist, the search results may display on top, an outstanding customer's invoice, contract agreement documents and other information relevant to the role of the user performing the search. If the customer service representative in the first example explicitly searches for the customer and invoice information, the data may not be presented at all in the search results due to access restrictions imposed on the searcher's role.

Entity instance scores are computed at real-time by the search engine 360 to determine the relevance of individual entity instances to the searcher in order to determine the order in which the search results are presented to the user. The search engine may use information stored in the metadata of the corresponding entity types to determine individual entity instance scores. The entity instance score is used to determine a document score for the document rendered 460 corresponding to the entity instance. The document score is used by the search engine to determine the relevance of search results, for example, a document with higher score is presented higher up in the order of search results compared to a document scored lower.

The score of an entity instance is determined based on several factors including: (1) Weighting controlled by a user with the required access permissions and expertise to edit the weighting information, for example an administrator or department head. The access to edit the weighting controls to users may be within their roles or enterprise-wide. (2) Ranking calculated based on the role of the searcher in the enterprise. For example, a different set of entities may be of interest to an executive of the company compared to the entities of interest to a person in-charge of technical support. (3) The position of the entity type corresponding to the entity instance in the hierarchy of entity types determined based on the entity type score. (4) The number of relation instances pointing at the entity instance from other entity instances. (5) A globalization index based on how many individual entity instances comprise a single global entity instance. For example, a global entity instance comprising a large number of individual entity instances that may be from different data silos is assigned higher score compared to a global entity instance comprising a single entity instance or fewer entity instances. (6) The frequency of transactions occurring in the entity instance. For a global entity comprising multiple entity instances, an aggregate value computed based on the frequency of transactions of the components entity instances is used. An entity instance with a large number of transactions is considered more significant to a searcher compared to an entity with very few transactions. For example, an entity representing a customer associated with a large number of sales transactions is more significant for a searcher who is a sales representative of a company compared to an entity representing a customer associated with very few sales transactions. (7) Importance of an entity instance determined by users of the search results. For example, explicit feedback may be requested from the user performing the search indicating the search results that the user considers significant. Alternatively, statistical data associated with the number of users that fetch more information associated with an entity instance returned in the search results is collected. The information may be collected in real-time or by post processing of the information stored in logs associated with the user searches. For example, entities that are examined by the searchers more frequently when returned as search results are considered more significant compared to entities that are consistently ignored by a significant number of users when returned in search results. The overall entity instance score is computed as an aggregate value, for example, a weighted sum of several individual scores computed based on a variety of factors described above.

### Alternative Embodiments

It is to be understood that the Figures and descriptions of the present invention have been simplified to illustrate elements that are relevant for a clear understanding of the present invention, while eliminating, for the purpose of clarity, many other elements found in a typical system that allows users to view report data. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for an integrated search across enterprise data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer implemented method for searching across an enterprise comprising a plurality of data silos, the method comprising:
extracting an information from each of said data silos, said information comprising entity types and relations between entity types;
merging a plurality of entity types from different data silos that represent the same underlying real world entity into a global entity type;
merging a plurality of relations between entity types when the source entities of the relation are merged together and the target entities of the relations are merged together;
storing entity instances as electronic documents and representing instances of relations between entity instances by electronic document references; and
indexing the documents stored to allow searching.

2. The method of claim 1, further comprising:
receiving a search request;
responsive to the search request, determining a list of electronic documents matching the search results, wherein the documents are ordered based on entity instance scores of the entity instances corresponding to the documents;
sending the list of documents;

3. The method of claim 1, wherein the data silos comprise relational databases and an entity type maps to a table and an entity type relation maps to a foreign key.

4. The method of claim 1, further comprising:
storing the entity types and the relations between entity types as XML documents.

5. The method of claim 1, wherein the entity instances are stored as HTML documents and a relation instance between a source entity instance and a target entity instance is stored as a hypertext link from the HTML document corresponding to the source entity instance to the HTML document corresponding to the target entity instance.

6. The method of claim 1, further comprising:
receiving user input to modify the entity types and entity type relations to better reflect the data stored in the data silos.

7. The method of claim 2, wherein the entity instance score is determined based on user input.

8. The method of claim 2, wherein the entity instance score is determined based on a role of a requestor of the search.

9. The method of claim 2, wherein the entity instance score is determined based on an entity type score of the entity type of the entity instance, wherein the entity instance score is determined based on the number of relations pointing at the entity type from one or more source entity types.

10. The method of claim 2, wherein the entity instance score is determined based on an entity type score of the entity type of the entity instance, wherein the entity instance score is determined based on an aggregate value determined based on entity type scores of one or more source entity types such that there is a relation pointing at the entity type from the source entity types.

11. The method of claim 2, wherein the entity instance score is determined based on a number of relation instances pointing at the entity instance from one or more source entity instances.

12. The method of claim 2, wherein the entity instance score is determined based on an aggregate value determined based on entity instance scores of one or more source entity instances such that there is a relation pointing at the entity instance from the source entity instances.

13. The method of claim 2, wherein the entity instance is associated with a global entity type comprising a plurality of entity types and the entity instance score is determined based on a cardinality of the plurality of entity types.

14. The method of claim 2, wherein the entity instance is associated with a global entity type comprising a plurality of entity types and the entity instance score is determined based on an aggregate value determined based on entity type scores associated with the entity types in the plurality of entity types.

15. The method of claim 2, wherein the entity instance score is determined based on a frequency of transactions associated with the entity instance.

16. The method of claim 11, wherein a high value of the frequency of transactions associated with the entity instance is indicative of higher entity instance score value.

17. The method of claim 2, wherein the entity instance is associated with an entity type and the entity instance score is determined based on a frequency with which requests for further information are received for entity instances of the entity type returned as search results.

18. The method of claim 2, wherein the information extracted from the data silos further comprises access control information associated with entity types.

19. A system for searching across an enterprise comprising a plurality of data silos, the system comprising:
a computer processor; and
a computer-readable storage medium storing computer program modules configured to execute on the computer processor, the computer program modules comprising:
a crawler module configured to:
extract an information from each of said data silos, said information comprising entity types and relations between entity types;
a federator module configured to:
merge a plurality of entity types from different data silos that represent the same underlying real world entity into a global entity type;
merge a plurality of relations between entity types when the source entities of the relation are merged together and the target entities of the relations are merged together;
store entity instances as electronic documents and represent instances of relations between entity instances by electronic document references; and
an index engine module configured to:
index the documents stored to allow searching.

20. A computer program product having a computer-readable storage medium storing computer-executable code for searching across an enterprise comprising a plurality of data silos, the code comprising:
a crawler module configured to:
extract an information from each of said data silos, said information comprising entity types and relations between entity types;
a federator module configured to:
merge a plurality of entity types from different data silos that represent the same underlying real world entity into a global entity type;
merge a plurality of relations between entity types when the source entities of the relation are merged together and the target entities of the relations are merged together;
store entity instances as electronic documents and represent instances of relations between entity instances by electronic document references; and
an index engine module configured to:
index the documents stored to allow searching.
